(19) United States
(12) Patent Application Publication
(10) Pub. No.: US 2008/0026110 A1
(43) Pub. Date: Jan. 31, 2008

(54) Defrost indicator for frozen products

(75) Inventors: Shay Cooper, Weymouth, MA (US); Varda Cooper, Tel Aviv (IL); Jonathan Levinboim, Herzliya (IL)

Correspondence Address: STERNE, KESSLER, GOLDSTEIN & FOX P.L.L.C., 1100 NEW YORK AVENUE, N.W., WASHINGTON, DC, 20005, US

(73) Assignee: ThawDog, LLC.

(21) Appl. No.: 11/812,995

(22) Filed: Jun. 22, 2007

Related U.S. Application Data
(60) Provisional application No. 60/815,855, filed on Jun. 23, 2006.

(51) Int. Cl. A23L 1/00; B01F 3/08; G01K 11/12

(52) U.S. Cl. 426/88; 374/162; 516/53; 516/9; 374/E11.018

(57) ABSTRACT

Disclosed is a defrost indicator that provides an irreversible indication that a frozen product has become thawed and unfrozen during any portion of time subsequent to its initial freezing. Also disclosed is a method for manufacturing a defrost indicator for frozen products. Further disclosed is a frozen product including a defrost indicator along with the frozen product packaging.

### PRIORITY CLAIM

This application claims the benefit of U.S. Provisional Application No. 60/815,855, filed 23 Jun. 2006, entitled “A Defrost Indicator for Frozen Products.”

### BACKGROUND OF THE INVENTION

1. Field of Invention

The present invention relates to a device that provides an irreversible indication if a frozen product has become thawed and unfrozen during any portion of time subsequent to its initial freezing.

2. Background Art

In order to properly maintain the quality of many products such as food, biological or pharmaceutical products, it is necessary for these products to be kept continuously below specific temperatures. Thus, it is important to know whether these required temperatures have been maintained throughout the entire time following the initial freezing of the products. However, it is not uncommon that such frozen products are temporarily defrosted or thawed and subsequently refrozen due to the changes of the storage conditions or other factors.

With regard to the frozen food products, thawing or defrosting even for a short period of time may encourage the growth of bacteria or damage cell structures, which could result in deterioration, spoilage and unfavorable odors and tastes. Foodborne disease is a public health concern in all parts of the world. In the United States, foodborne disease causes an estimated 76 million illnesses, 325,000 hospitalizations, and 5,000 deaths each year. According to the Center for Disease Control and Prevention, among all types of foodborne disease, 30% are caused by bacteria. The risk of foodborne illness could be reduced by an improved technique for determining whether food is safe for consumption.

For various biological or pharmaceutical products that are required to be kept below specific temperatures, temporary defrosting could cause them to become unsafe or otherwise result in a loss of therapeutic effects. Moreover, premature thawing and subsequent refreezing of food, biological or pharmaceutical products is often difficult or impossible to detect based on the appearance of the product alone.

Thus, a need exists for a defrost indicator for frozen products that can accurately, reliably and readily indicate whether the frozen products have become thawed and unfrozen during any portion of time subsequent to their initial freezing. A need also exists for a defrost indicator for frozen products that can be easily and inexpensively made and used.

### SUMMARY OF THE INVENTION

The present invention relates to a defrost indicator that provides an irreversible indication that a frozen product has thawed and become unfrozen during any portion of time subsequent to its initial freezing. More particularly, the defrost indicator of this invention is inserted into or affixed to a product packaging to indicate to a potential user whether the frozen product has been thawed and refrozen subsequent to its initial freezing.

One aspect of the invention is directed to a defrost indicator comprising a transparent container containing an emulsion comprising between about 5% and about 95% by weight of an edible oil and between about 5% and about 95% by weight of water, and optionally a dye; provided that said emulsion is substantially free of an emulsifier. The emulsion has a semi-opaque to opaque homogeneous appearance. Upon a thawing event the emulsion separates into two liquid phases, each having a distinct color or appearance. Thawing temperatures can be predetermined by formulating the emulsion with particular ingredients. The two phases remain separated with two distinct colors or appearances upon refreezing.

Another aspect of the invention is directed to a frozen food product including product packaging with typewritten directions for determining whether the frozen food product has been thawed based on a defrost indicator. If the defrost indicator has a semi-opaque to opaque homogeneous appearance, it has been continuously frozen subsequent to its initial freezing. If the defrost indicator shows two separate and distinct colors or appearances, it has been thawed subsequent to its initial freezing.

An additional aspect of the invention is directed to a frozen product to which a defrost indicator of the present invention is attached. The defrost indicator is either inserted inside a frozen product package or affixed to a frozen product package during the packaging process on the production line.

An additional aspect of the invention is directed to a method for manufacturing a defrost indicator. The defrost indicator can be manufactured by mixing a first liquid and a second liquid to form an emulsion. The first liquid and the second liquid are selected such that the emulsion will separate if stored above a particular temperature (i.e., in the case of a thawing event). For example, the liquids could be selected such that if the temperature of the emulsion rises above 32 degrees Fahrenheit (or a different temperature), the emulsion will separate within five minutes. Various combinations of liquids can be produced having various maximum separation times at various threshold temperatures.

Typically, the first liquid is of a different color (or appearance) than the second liquid so that the separation of the emulsion will be readily noticeable by a consumer. The emulsion is included in a transparent container, which is frozen before the emulsion can separate.

Additional embodiments and advantages of the invention will be set forth in part in the description that follows, and will flow from the description, or may be learned by practice of the invention. The embodiments and advantages of the invention will be realized and attained by means of the elements and combinations particularly pointed out in the appended claim.

It is to be understood that both the foregoing summary and the following detailed description are exemplary and explanatory only and are not restrictive of the invention, as claimed.

### BRIEF DESCRIPTION OF THE DRAWINGS

In the drawings:

FIG. 1 is a side view of a pouch form of the defrost indicator of the present invention.

FIG. 2 is a side view of a capsule form of the defrost indicator of the present invention.

FIG. 3 is a photograph of a flat bag form of the defrost indicator of the present invention.

FIG. 4 is a photograph of frozen meat products with attached defrost indicators of the present invention.

FIG. 5 is a photograph of samples of the invention starting to separate into two distinct colors or appearances upon thawing.

FIG. 6 is a photograph of samples of the invention having water with red food dye (down) and Canola oil (left), Olive oil (right), after thawing.

### DETAILED DESCRIPTION OF THE DISCLOSED EMBODIMENT

One aspect of the invention is directed to a defrost indicator comprising a transparent container containing an emulsion comprising between about 5% and about 95% by weight of an edible oil and between about 5% and about 95% by weight of water, preferably between about 20% and about 80% by weight of an edible oil and between about 20% and about 80% by weight of water, and optionally a dye; provided that said emulsion is substantially free of an emulsifier. The emulsion has a semi-opaque to opaque homogeneous appearance. Upon a thawing event the emulsion separates into two liquid phases, each having a distinct color or appearance. Thawing temperatures can be predetermined by formulating the emulsion with particular ingredients. The two phases remain separated with two distinct colors or appearances upon refreezing.

As used here, “opaque” is used in its ordinary meaning. “Freezing,” as used in the specification and claim, means transformation of a substance from liquid to solid by lowering the temperature below the freezing point of the substance. The freezing point can include temperatures at, above, or below 32° F. (0° C.). “Thawing” or “defrosting” means transformation of a substance from solid to liquid by raising the temperature above the melting point of the substance. The melting point can include temperatures at, above, or below 32° F. (0° C.). The terms “a” and “an” refer to one or more.

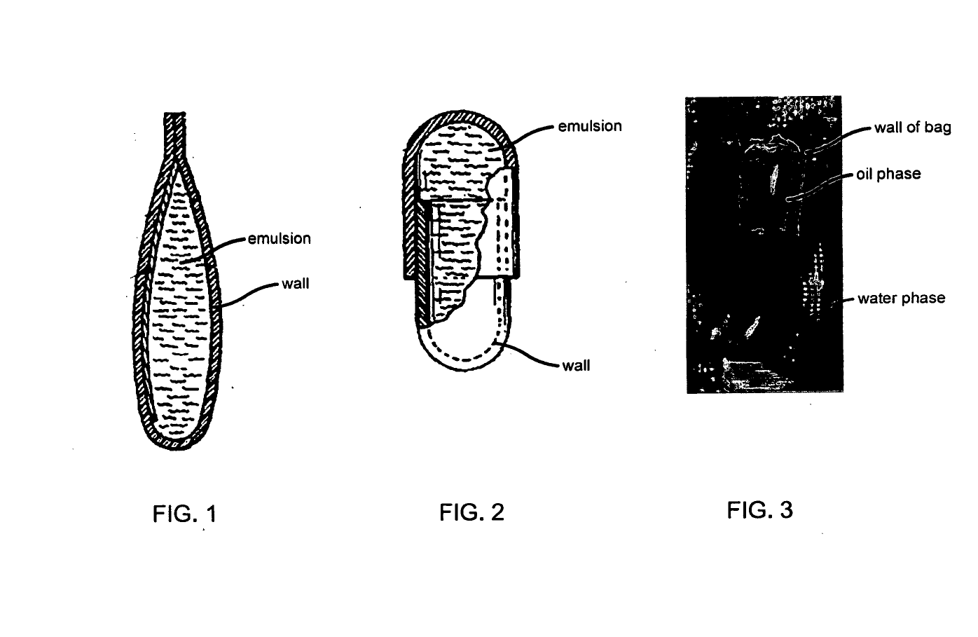

The transparent container may be a plastic pouch or capsule, or a flat plastic bag and the like. FIGS. 1 to 3 illustrate the different forms or shapes of the container. The plastic materials useful for this invention include polyolefin, polyester and any other conventional plastic materials. Preferably, the plastic materials are food grade materials.

Furthermore, on or adjacent to the container, there may be an instruction denoting how to use the defrost indicator. More specifically, on the plastic pouch, capsule or flat bag, there may be a printed instruction of checking the appearance of the pouch, capsule or flat bag to ascertain if a frozen product to which the pouch, capsule or flat bag is attached to has thawed at any point. If the pouch, capsule or flat bag has a semi-opaque to opaque homogeneous appearance, it has been continuously frozen subsequent to its initial freezing. If the pouch, capsule or flat bag shows two separate and distinct colors or appearances, it has been thawed. Thus, for the illustrative purpose here only, the instruction on or adjacent to the container can read “Opaque Color- Frozen; Two Colors-Thawed.”

The emulsion employed in this invention is a semi-opaque to opaque emulsion that will freeze at a predetermined temperature and has a semi-opaque to opaque homogeneous appearance in its frozen and unfrozen states.

A wide variety of emulsions may be employed without departing from the scope of the present invention. Such emulsions include oil-in-water type and water-in-oil type. Typically, the emulsion will have the property that if stored above a particular temperature they will separate into at least two phases within some expected period of time. Particularly, according to various embodiments of the present invention, no emulsifier, such as a fatty acid salt or phospholipid, is added to the emulsion. By freezing the emulsion promptly after formation, a defrost indicator can be manufactured without use of emulsifiers. Forming an emulsion without adding an emulsifier ensures that the emulsion readily breaks and separates into two continuous liquid phases upon a thawing event. An emulsifier-free defrost indicator is advantageous because it can be more sensitive to defrost events and avoids health concerns related to consumption of emulsifiers.

Any edible oils are suitable for this invention. Preferably, vegetable oils, such as corn oil, cottonseed oil, canola oil, rapeseed oil, olive oil, palm oil, peanut oil, ground nut oil, safflower oil, sesame oil, soybean oil and sunflower oil are used. The vegetable oils are inexpensive and give a natural yellow, brown or green color.

No particular type of water is required for this invention. Tap water, mineral water, distilled water, filtered water and/or deionized water can all be used to prepare the emulsion. Other lipids and non-lips can be used to form the emulsion without departing from the scope of the present invention.

Depending on the application, it may be desired that the defrost indicator change states at a particular temperature. In the case that the required freezing temperature for a product is lower than 32° F. (0° C.), a freezing point depressant can be included into the emulsion. According to various embodiments of the present invention, a freezing point depressant can be included in the emulsion by adding the freezing point depressant to an ingredient of the emulsion prior to emulsification, or by adding the freezing point depressant to the emulsion after emulsification.

A variety of ingredients, such as salt, sugar and other known agents for oil-in-water or water-in-oil emulsions, can be used to depress the freezing point of the emulsion. For example, salts can be included such as sodium chloride, potassium chloride and the like. As another example, sugars can be included such as monosaccharides, disaccharides, and the oligosaccharides. As yet another example, alcohol can be included in the emulsion to lower the freezing point. A freezing temperature range of between −20° C. and 0° C. can be achieved by adjusting the type and the amount of the freezing point depressant employed in the emulsion. In some cases a freezing point as low as −40° C. (or possibly lower) can be achieved. Based on this disclosure, a person skilled in the art can formulate an emulsion with a freezing point depressant to obtain the desired freezing temperature. By using freezing point depressants that are known to be safe for human consumption, the risk of contamination of frozen products by the defrost indicator can be deduced.

In one embodiment of the invention, no dye is added into the emulsion. The natural yellow, brown or green color of the oil phase and the colorless water phase provide conspicuous indication of two separate and distinct colors or appearances resulted from the thawing of the emulsion. In another embodiment of the invention, a dye is added to the water-in-oil emulsion to provide a stronger color contrast between the oil phase and water phase when the emulsion thaws and refreezes. In another embodiment of the invention, a dye is added to the oil-in-water emulsion to provide a stronger color contrast between the oil phase and water phase when the emulsion thaws and refreezes. The dyes suitable for this invention are non-toxic, preferably approved as food additives by a government regulatory agency. The dyes are either water soluble or oil soluble, preferably water soluble. The dyes can be in solid or liquid forms, or be dispersed in the oil or water that is used to prepare the emulsion.

To make the emulsion of this invention, all the ingredients are weighed into a mixer. The mixture is agitated vigorously to form an emulsion. Optionally, a pressurized mixer can be used to facilitate the emulsion. Generally, methods that provide high shear mixing can be employed to form emulsions in the absence of surfactant or emulsifiers. The emulsion so formed is stable at room temperature for a period of time to allow it to be packaged and frozen without phase separation.

To make the defrost indicator, the emulsion prepared according to this invention is filled into a transparent container described above. The container is then sealed at the open end by conventional means. In the case of a plastic flat bag, the bag is sealed by using a hot press at the open end.

Another aspect of the invention is directed to a method for determining whether a frozen product to which a defrost indicator of the present invention is attached, had thawed by visually inspecting the defrost indicator. The defrost indicator contains a liquid emulsion comprising between about 5% and about 95% by weight of an edible oil and between about 5% and about 95% by weight of water, preferably between about 20% and about 80% by weight of an edible oil and between about 20% and about 80% by weight of water, and optionally a dye.

The selection of mixtures for the emulsion can be based on a variety of factors. Visibility of a thawing event is typically highest near mixtures of approximately 50/50 oil and water by volume. To reduce the cost of manufacture, it may be desirable to include more water than oil in the emulsion. To further reduce the cost of manufacture, recycled food oils can be included in the emulsion. For example, canola oil used for the industrial frying of potato chips can be used to produce the defrost indicator, thereby advantageously reducing cost and providing an environmentally friendly avenue for waste oil disposal. In another embodiment, the emulsion can be formed using food products to accompany the frozen food product. For example, an oil and vinegar marinade for a frozen chicken breast could be emulsified and frozen, efficiently providing both detection of thawing events and delivery of the marinade by the same apparatus.

The liquid emulsion has a semi-opaque to opaque homogeneous appearance. When the liquid emulsion freezes, it gives a semi-opaque to opaque homogeneous appearance. When the emulsion thaws, it separates into two liquid phases, i.e., the oil phase and the water phase, each having a distinct color or appearance. Upon refreezing, the oil phase and water phase remain separated and have two separate and distinct colors or appearances resulted from the oil phase and the water phase.

The defrost indicator containing a liquid emulsion as described above, is attached to a package of product and stored in the frozen state. If the frozen product thaws, the emulsion in the defrost indicator will also thaw and separates into an oil phase and water phase having two separate and distinct colors or appearances. Upon refreezing, the oil phase and water phase remain separated and have two separate and distinct colors or appearances, leaving evidence that the frozen product has been thawed subsequent to its initial freezing. The frozen products include but are not limited to frozen foods, biological and pharmaceutical products. The frozen foods include but are not limited to meat, vegetables and dairy products.

An additional aspect of this invention is directed to a frozen product to which a defrost indicator of the present invention is attached. In one embodiment of the invention, the defrost indicator is inserted inside a food or pharmaceutical package to be frozen, and then the entire assembly is frozen at a predetermined temperature. In another embodiment of the invention, the defrost indicator is affixed to the outside of a food or pharmaceutical package to be frozen. In the latter instance, a conventional attachment means can be used for such purpose. The conventional attachment means include adhesion, “hook and loop fastener,” wrapping, clamping, clipping and the like. Preferably, an adhesive backing is applied to one part of the defrost indictor so that it can be fastened onto a food or pharmaceutical package. Then, the entire assembly is frozen at a predetermined temperature. Since the defrost indicator can be either inserted inside a frozen product package or affixed to a frozen product package during the packaging process on the production line, this allows anyone to follow and review the conditions and status of the frozen product all the way from the manufacturing floor to the retailer and finally to the hands of the consumer. It will also give the consumer a simple and visible indication as to whether the frozen product had been continuously frozen subsequent to its initial freezing.

The advantages of various embodiments of the present invention include:
The emulsion of the invention is sealed within a container. Therefore, the emulsion has no direct contact with the frozen products.
The ingredients of the emulsion of the invention are edible or food grade. Therefore, the indicator poses no health risk in the event of breakage of the indicator and leakage of the emulsion.
The emulsion can be formed without use of an emulsifier, thereby reducing cost, avoiding certain health risks, and increasing the sensitivity of the defrost indicator to thaw events.
It is extremely difficult to “re-emulsify” the separated two liquid phases upon thawing of the emulsion without the aid of emulsification equipment. Therefore, it is tamper-free.
The indicator gives a very clear indication to the user.
The indicator can be easily and inexpensively made and used in a wide array of applications.

The following examples are illustrative, but not limiting, of the device, products and methods of the present invention. Suitable modifications and adaptations of the variety of conditions, formulations and other parameters normally encountered in the filed and which are obvious to those skilled in the art in view of this disclosure are within the spirit and scope of the invention.

### EXAMPLE 1

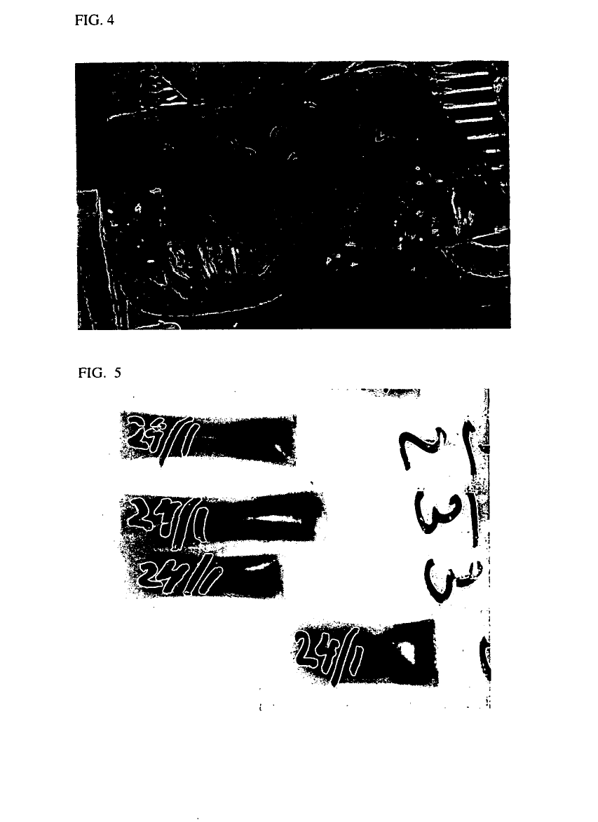

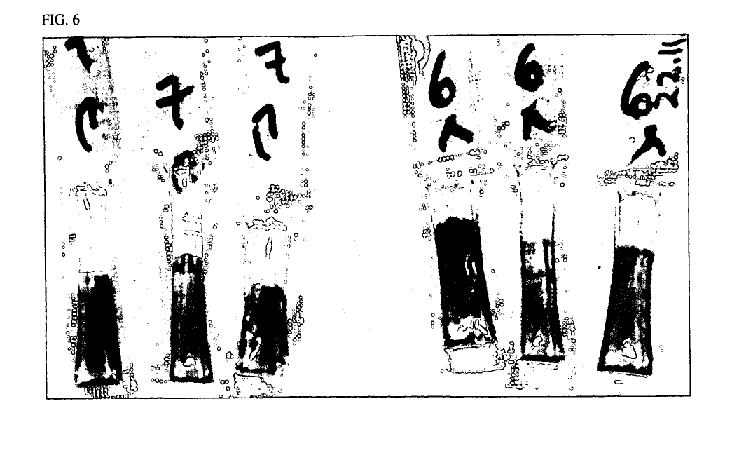

A mixture is prepared from 50 parts (by weight) of drinking water and 50 parts of canola oil at the room temperature. The mixture is then agitated vigorously in a mixer to form an emulsion. Before the emulsion can separate, the emulsion prepared above is injected into a transparent plastic flat bag resembling the one described in FIG. 3. The bag is then sealed at the open end by a hot press. The sealed bag is inserted into a food package to be frozen, see FIG. 4. Then, the entire assembly is sent to a freezer. While the bag remains continuously frozen, it has a semi-opaque to opaque homogeneous appearance. Subsequent to being subjected to a temperature above the freezing point of the emulsion, the emulsion breaks and separates into a yellow oil phase and a colorless water phase. The two phases remain separated with two distinct colors or appearances indicating the occurrence of thawing event, even if the assembly is subsequently refrozen.

### EXAMPLE 2

A mixture is prepared from 40 parts (by weight) of drinking water and 60 parts of olive oil and 0.03 parts of water soluble red food dye at the room temperature. The mixture is then agitated vigorously in a mixer to form an emulsion. Before the emulsion can separate, the emulsion prepared above is injected into a transparent plastic flat bag resembling the one described in FIG. 3, which has an adhesive backing on one side of wall so that it can be affixed to a food package. The bag is then sealed at the open end by a hot press. The sealed bag is affixed to a food package to be frozen. Then, the entire assembly is sent to a freezer. While the bag remains continuously frozen, it has a semi-opaque to opaque homogeneous appearance. Subsequent to being subjected to a temperature above the freezing point of the emulsion, the emulsion breaks and separates into a yellow oil phase and a red water phase. The two phases remain separated with two distinct colors or appearances indicating the occurrence of thawing event, even if the assembly is subsequently refrozen.

Having now fully described this invention, it will be understood by those of ordinary skill in the art that the same can be performed within a wide and equivalent range of conditions, formulations and other parameters without affecting the scope of the invention or any embodiment thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claim.

What is claimed is:

1. A defrost indicator, comprising a transparent container containing an emulsion comprising between 5% and 95% by weight of an edible oil and between 5% and 95% by weight of water; provided that said emulsion is substantially free of an emulsifier; wherein said emulsion separates into two liquid phases, each having a distinct color or appearance upon the occurrence of a thawing event at a predetermined temperature; and wherein said two phases remain separated with two distinct colors or appearances upon refreezing at said predetermined temperature.

2. The defrost indicator of claim 1, wherein the emulsion further comprises a water-soluble dye.

3. The defrost indicator of claim 1, wherein the emulsion further comprises an oil-soluble dye.

4. The defrost indicator of claim 1, wherein the emulsion further comprises a freezing point depressant.

5. A frozen product comprising a defrost indicator, the defrost indicator comprising a transparent container containing an emulsion comprising between 5% and 95% by weight of oil and between 5% and 95% by weight of water; provided that said emulsion is substantially free of an emulsifier; wherein said emulsion separates into two liquid phases, each having a distinct color or appearance upon the occurrence of a thawing event at a predetermined temperature; and wherein said two phases remain separated with two distinct colors or appearances upon refreezing at said predetermined temperature.

6. A method for manufacturing a defrost indicator, the method comprising:
mixing a first liquid and a second liquid to form an emulsion, wherein said first liquid is a different color than said second liquid, and wherein said first liquid will naturally separate from said second liquid within a first period of time if stored above a first temperature;
including the emulsion in a transparent container; and
freezing the transparent container while the first liquid and the second liquid remain in an emulsified state.

7. The method of claim 6, wherein the first liquid comprises a lipid.

8. The method of claim 7, wherein the first liquid further comprises a lipid-soluble dye.

9. The method of claim 6, wherein the first liquid comprises an edible oil.

10. The method of claim 6, wherein the first liquid comprises a recycled oil.

11. The method of claim 6, wherein the first liquid comprises a non-lipid.

12. The method of claim 11, wherein the first liquid further comprises a water-soluble dye.

13. The method of claim 6, wherein said first period of time is less than twenty-four hours.

14. The method of claim 13, wherein said first period of time is less than two hours.

15. The method of claim 14, wherein said first temperature is thirty-two degrees Fahrenheit.

16. The method of claim 6, further comprising the step of:
including the transparent container in a frozen product.

17. The method of claim 6, wherein mixing the first liquid and the second liquid to form the emulsion comprises agitating a mixture of the first liquid and second liquid.

18. The method of claim 6, wherein mixing the first liquid and the second liquid to form the emulsion comprises mixing the first liquid and the second liquid under pressure.

19. The method of claim 6, further comprising the step of:
including a freezing point depressant in the emulsion.

20. A frozen food product comprising:
a frozen food item;
a food packaging; and
a defrost indicator, said defrost indicator including an emulsion comprising at least a first liquid and a second liquid which will naturally separate if stored above a first temperature, wherein the food packaging further includes typewritten instructions for determining whether the frozen food item has been thawed based on a state of the defrost indicator.

21. The frozen food product of claim 20, wherein said food packaging has an interior and an exterior, and said defrost indicator is included on the interior of said food packaging.

22. The frozen food product of claim 20, wherein said food packaging has an interior and an exterior, and said defrost indicator is included on the exterior of said food packaging.
